(19) United States
(12) Patent Application Publication
(10) Pub. No.: US 2019/0354952 A1
(43) Pub. Date: Nov. 21, 2019

(54) TERMINAL CONTROL APPARATUS AND PROGRAM FOR TERMINAL CONTROL APPARATUS AND STORE SYSTEM

(71) Applicant: TOSHIBA TEC KABUSHIKI KAISHA, Tokyo (JP)

(72) Inventor: Yukiko Yokoyama, Sunto Shizuoka (JP)

(21) Appl. No.: 16/412,578

(22) Filed: May 15, 2019

(30) Foreign Application Priority Data
May 16, 2018 (JP) 2018-094375

(51) Int. Cl. G06Q 20/20; G06Q 20/40

(52) U.S. Cl. CPC G06Q 20/206; G06Q 30/0633; G06Q 20/40145

(57) ABSTRACT

A terminal control apparatus acquires identification information of a user. The terminal control apparatus acquires biological information of the user read by a biological information reading device provided in a truck. The terminal control apparatus detects, from a first storing section that stores, in association with the identification information of a plurality of users, registered biological information registered as biological information of the user identified by the identification information, the registered biological information stored in association with the acquired identification information and collates the detected registered biological information and the acquired biological information. The terminal control apparatus starts, if the biological information coincides with the registered biological information as a result of the collation, a terminal for inputting information concerning a commodity that the user loads on the truck.

### CROSS-REFERENCE TO RELATED APPLICATION

This application is based upon and claims the benefit of priority from Japanese Patent Application No. 2018-094375, filed in May 16, 2018, the entire contents of which are incorporated herein by reference.

### FIELD

Embodiments described herein relate generally to a store system and a terminal control apparatus used in the store system and a program for causing a computer to function as the terminal control apparatus.

### BACKGROUND

In recent years, a store system called cart POS (Point Of Sales) system has been examined in a retail store such as a supermarket. The cart POS system uses a truck for loading commodities purchased by a customer, a so-called shopping cart. A terminal including a scanner is provided in the shopping cart. The terminal receives operation for login authentication. If login is approved, the terminal starts and is capable of receiving an input of information concerning the commodities purchased by the customer.

The login authentication of the terminal is generally authentication by a user ID (Identification) using a member card, a smartphone, or the like. However, the authentication by the user ID cannot surely prevent identity fraud by an outsider. Therefore, application of biological authentication using a fingerprint, an iris, or the like to the login authentication of the terminal has been examined.

If the biological authentication is applied to the login authentication of the terminal, biological information acquired from the customer who uses the shopping cart is collated with biological information of all customers registered in a database. Therefore, it takes time to collate the biological information and the start of the terminal is delayed. There is a concern that the customer feels the delay unpleasant.

### DESCRIPTION OF THE DRAWINGS

FIG. 1 is an overall configuration diagram of a store system according to a first embodiment;

FIG. 2 is a block diagram illustrating a main part circuit configuration of an information terminal included in the store system;

FIG. 3 is a perspective view illustrating an example of a cart in which the information terminal is provided;

FIG. 4 is a block diagram illustrating a main part circuit configuration of an accounting machine included in the store system;

FIG. 5 is a block diagram illustrating a main part circuit configuration of a store server included in the store system;

FIG. 6 is a schematic diagram illustrating a main data structure of a member data record described in a member database included in the store server;

FIG. 7 is a schematic diagram illustrating a data structure of a shopping file formed by the store server;

FIG. 8 is a flowchart illustrating a procedure of main information processing executed by a processor of the store server;

FIG. 9 is a flowchart illustrating the procedure; and

FIG. 10 is a flowchart illustrating the procedure.

### DETAILED DESCRIPTION

An object of embodiments is to provide a terminal control apparatus and a store system that can reduce a time required for authentication necessary for a start of a terminal while surely preventing identity fraud by an outsider using biological authentication.

According to an embodiment, a terminal control apparatus includes an identification-information acquiring section, a first biological-information acquiring section, a first collating section, and a starting section. The identification-information acquiring section acquires identification information of a user. The first biological-information acquiring section acquires biological information of the user read by a biological information reading device provided in a truck. The first collating section detects, from a first storing section that stores, in association with the identification information of a plurality of users, registered biological information registered as biological information of the user identified by the identification information, the registered biological information stored in association with the identification information acquired by the identification-information acquiring section and collates the detected registered biological information and the biological information acquired by the first biological-information acquiring section. The starting section starts, if the biological information coincides with the registered biological information as a result of the collation by the first collating section, a terminal for inputting information concerning a commodity that the user loads on the truck.

An embodiment of a terminal control apparatus and a store system that can reduce a time required for authentication necessary for a start of a terminal while surely preventing identity fraud by an outsider using biological authentication. In this embodiment, the biological authentication is fingerprint authentication.

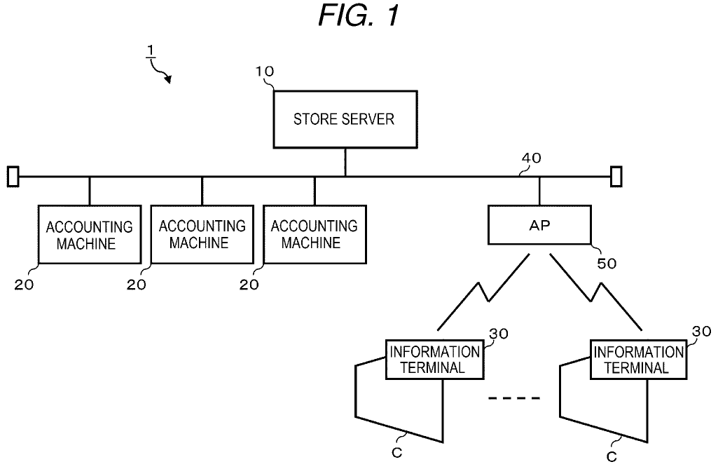

FIG. 1 is an overall configuration diagram of a store system 1 according to this embodiment. The store system 1 includes a store server 10, an accounting machine 20, and an information terminal 30. The information terminal 30 is provided in a shopping cart C (hereinafter abbreviated as cart C). Information terminals 30 are respectively provided in a plurality of carts C. The cart C is an example of a truck for loading and carrying commodities purchased by a customer, who is a user of the cart C.

The store server 10 and the accounting machine 20 are connected to a network 40 such as a LAN (Local Area Network). An access point 50 is also connected to the network 40. The information terminal 30 includes a wireless unit. The information terminal 30 performs wireless communication with the access point 50. The access point 50 relays communication between devices, that is, the store server 10 and the accounting machine 20 connected to the network 40 and the information terminal 30. Only one access point 50 is illustrated in FIG. 1. However, two or more access points 50 may be provided depending on a size and the like of a store.

The information terminal 30 is a device with which a customer himself or herself performs information input and the like of commodities purchased by the customer. The accounting machine 20 is a device with which the customer himself or herself performs accounting of the commodities purchased by the customer. That is, the store system 1 is a self-type store system with which the customer himself or herself performs the information input to the accounting of the commodities purchased by the customer.

A plurality of accounting machines 20 may be set in one store. In FIG. 1, the store system 1 including three accounting machines 20 set in one store is illustrated.

The store server 10 controls a start of the information terminals 30. The store server 10 creates list data of commodities purchased by a customer from information concerning the commodities input by the started information terminal 30. The store server 10 specifies a customer who uses the accounting machine 20 and transmits list data of commodities purchased by the customer to the accounting machine 20. The store server 10 functions as a terminal control apparatus that controls the information terminal 30.

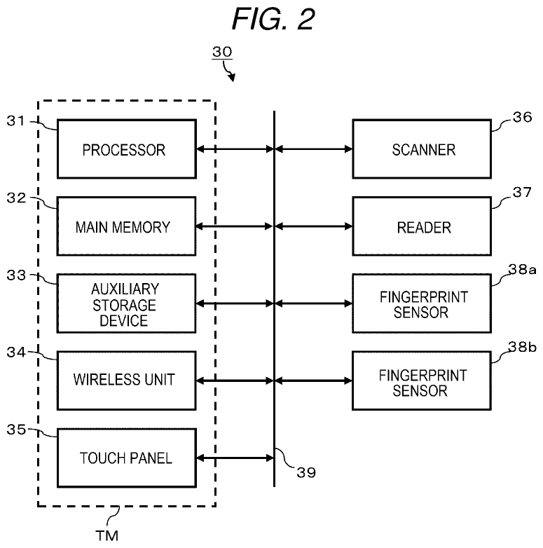

FIG. 2 is a block diagram illustrating a main part circuit configuration of the information terminal 30. The information terminal 30 includes a processor 31, a main memory 32, an auxiliary storage device 33, a wireless unit 34, a touch panel 35, a scanner 36, a reader 37, a first fingerprint sensor 38a, a second fingerprint sensor 38b, and a system transmission path 39. The system transmission path 39 includes an address bus, a data bus, and a control signal line. In the information terminal 30, the processor 31, the main memory 32, the auxiliary storage device 33, the wireless unit 34, the touch panel 35, the scanner 36, the reader 37, the first fingerprint sensor 38a, and the second fingerprint sensor 38b are connected to the system transmission path 39. In the information terminal 30, a computer is configured by the processor 31, the main memory 32, and the auxiliary storage device 33 and the system transmission path 39 that connects these devices.

The processor 31 is equivalent to a center portion of the computer. The processor 31 controls the sections in order to realize various functions of the information terminal 30 according to an operating system or application programs. The processor 31 is, for example, a CPU (Central Processing Unit).

The main memory 32 is equivalent to a main storage portion of the computer. The main memory 32 includes a nonvolatile memory region and a volatile memory region. The main memory 32 stores the operating system or the application programs in the nonvolatile memory region. The main memory 32 sometimes stores, in the nonvolatile or volatile memory region, data necessary for the processor 31 to execute processing for controlling the sections. The main memory 32 uses the volatile memory region as a work area in which data is rewritten as appropriate by the processor 31. The nonvolatile memory region is, for example, a ROM (Read Only Memory). The volatile memory region is, for example, a RAM (Random Access Memory).

The auxiliary storage device 33 is equivalent to an auxiliary storage portion of the computer. For example, an EEPROM (Electric Erasable Programmable Read-Only Memory), a HDD (Hard Disc Drive), an SSD (Solid State Drive), or the like can be the auxiliary storage device 33. The auxiliary storage device 33 saves data used by the processor 31 in performing various kinds of processing, data created by processing in the processor 31, or the like. The auxiliary storage device 33 sometimes stores the application programs.

The wireless unit 34 controls wireless communication performed according to a wireless communication protocol between the wireless unit 34 and the access point 50.

The touch panel 35 is a device including both of an input device and a display device of the information terminal 30. The touch panel 35 detects a touch position on a displayed image and outputs information concerning the touch position to the processor 31.

The scanner 36 reads a code symbol such as a barcode or a two-dimensional data code attached to a commodity. The scanner 36 outputs data of the read code symbol to the processor 31. The scanner 36 may be a type for reading the code symbol with scanning of a laser beam or may be a type for reading the code symbol from an image captured by an imaging device.

The reader 37 reads data recorded in a recording medium and outputs the read data to the processor 31. The reader 37 is a magnetic card reader if the recording medium is a magnetic card. The reader 37 is an IC card reader if the recording medium is a contact IC card. An RFID reader is used as the reader 37 in the case of a recording medium that uses RFID (Radio Frequency Identification) such as a noncontact IC card or a smartphone.

The recording medium includes a member card. In this embodiment, a customer who uses the store system 1 is requested to perform membership registration beforehand. To the customer registered as a member, a peculiar user ID is allocated as identification information of the customer and a member card in which the user ID is recorded is issued. The reader 37 is capable of reading the user ID recorded in the member card. That is, the reader 37 functions as an identification information reading device for reading identification information, that is, a user ID of a customer who moves the cart C. The user ID may be recorded in the member card as electronic data or may be recorded in the member card in a form of printing of a code symbol such as a barcode.

The first fingerprint sensor 38a and the second fingerprint sensor 38b reads a fingerprint of a person with, for example, a capacitance system and outputs read fingerprint data to the processor 31. Specifically, the first fingerprint sensor 38a and the second fingerprint sensor 38b detect unevenness of a finger put on a sensor section as a ratio of electric charges accumulated in an electrode of the sensor section and convert an amount of the electric charges into a fingerprint image and output the fingerprint image to the processor 31. The first fingerprint sensor 38a and the second fingerprint sensor 38b are not limited to the capacitance system. For example, a fingerprint sensor of an optical system, a field intensity measurement system, a pressure sensitive system, or a thermosensitive system may be used as the first fingerprint sensor 38a and the second fingerprint sensor 38b.

In the information terminal 30 including the circuit component elements explained above, the processor 31, the main memory 32, the auxiliary storage device 33, the wireless unit 34, and the touch panel 35 are configured by a tablet terminal TM. The information terminal 30 is configured by electrically connecting the scanner 36, the reader 37, the first fingerprint sensor 38a, and the second fingerprint sensor 38b to the tablet terminal TM.

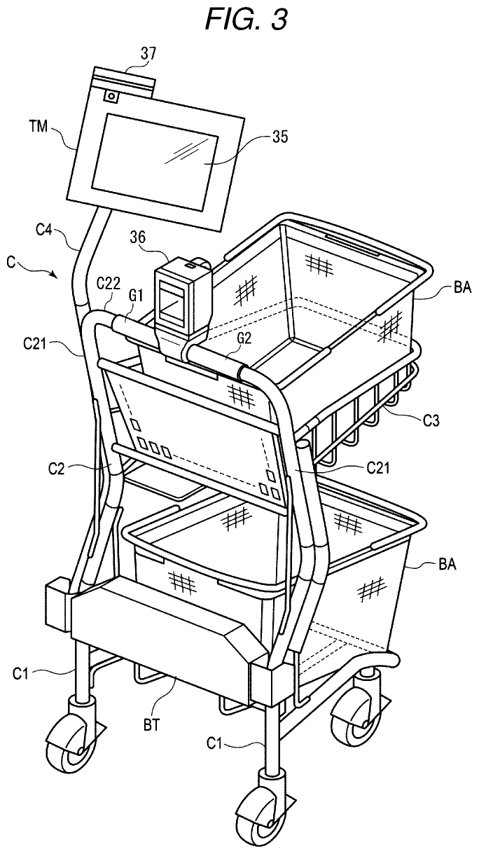

FIG. 3 is a perspective view illustrating an example of the cart C in which the information terminal 30 is provided. The cart C includes a caster section C1 for movement, a handle frame section C2, and a basket receiving section C3. The caster section C1 includes four wheels for smoothly moving the cart C on a floor surface. The handle frame section C2 includes a pair of vertical frames C21 and C21 erected on a rear wheel side of the caster section C1 and a handlebar C22 that couples upper ends of the vertical frames C21 and C21. The basket receiving section C3 is present in the front of the middle part of the handle frame section C2. A shopping basket BA for storing commodities can be placed on the basket receiving section C3 and the caster section C1 of the cart C.

The scanner 36 is present in the middle part of the handlebar C22. The scanner 36 is attached to the handlebar C22 such that a reading window is located on a near side. The near side is a side where a customer pushing the cart C stands while holding the handlebar C22.

A pole C4 is attached to one vertical frame C21. The distal end of the pole C4 is located above the handlebar C22. The tablet terminal TM is attached to the distal end portion of the pole C4 with a screen of the touch panel 35 facing the near side. The reader 37 is attached to the table terminal TM to locate a card slit on the near side. In FIG. 3, the reader 37 is a magnetic card reader. A battery BT is attached on the lower end side of the handle frame section C2 between the vertical frames C21 and C21. The battery BT is a driving power supply for the tablet terminal TM and the scanner 36.

Grips G1 and G2 are attached to the handlebar C22 to cover the outer circumferences of bars on the left and the right of the scanner 36. The customer grasps the grips G1 and G2 to move the cart C. The customer grasps the grips G1 and G2 as an act for moving the cart C. The first fingerprint sensor 38a and the second fingerprint sensor 38b are provided in the grips G1 and G2. Specifically, the surface of the grip G1 is formed as a protective film for a sensor section and an electrode of the sensor section is dispose on the rear surface side of the protective film, whereby the first fingerprint sensor 38a for reading a fingerprint of the left hand of the customer grasping the grip G1 is configured. Similarly, the surface of the grip G2 is formed as a protective film for a sensor section and an electrode of the sensor section is disposed on the rear surface side of the protective film, whereby the second fingerprint sensor 38b for reading a fingerprint of the right hand of the user grasping the grip G2 is configured. The first fingerprint sensor 38a and the second fingerprint sensor 38b function as biological information reading device for reading a fingerprint, which is a kind of biological information, of the user who moves the cart C. Typically, the user is a customer who loads commodities to be purchased on the cart C and carries the commodities. That is, the first fingerprint sensor 38a and the second fingerprint sensor 38b are capable of reading a fingerprint of the customer from an act for moving the customer C of the customer.

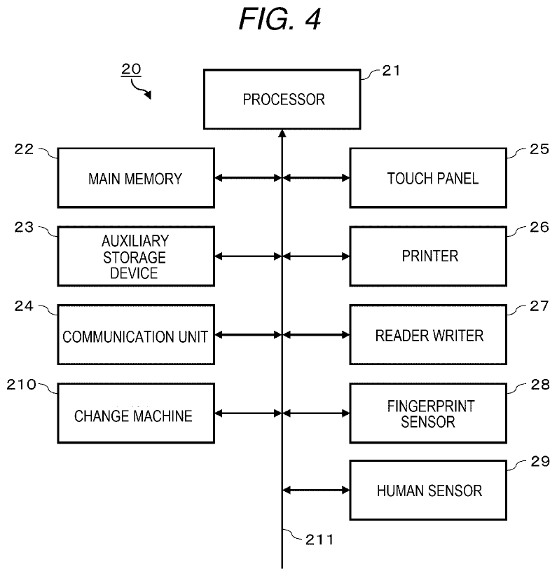

FIG. 4 is a block diagram illustrating a main part circuit configuration of the accounting machine 20. The accounting machine 20 includes a processor 21, a main memory 22, an auxiliary storage device 23, a communication unit 24, a touch panel 25, a printer 26, a reader writer 27, a fingerprint sensor 28, a human sensor 29, a change machine 210, and a system transmission path 211. The system transmission path 211 includes an address bus, a data bus, and a control signal line. In the accounting machine 20, the processor 21, the main memory 22, the auxiliary storage device 23, the communication unit 24, the touch panel 25, the printer 26, the reader 37, the fingerprint sensor 28, and the human sensor 29 are connected to the system transmission path 211. In the accounting machine 20, a computer is configured by the processor 21, the main memory 22, and the auxiliary storage device 23 and the system transmission path 211 that connects these devices.

The processor 21 is equivalent to a center portion of the computer. The processor 21 controls the sections in order to realize various functions of the accounting machine 20 according to an operating system or application programs. The processor 21 is, for example, a CPU.

The main memory 22 is equivalent to a main storage portion of the computer. The main memory 22 includes a nonvolatile memory region and a volatile memory region. The main memory 22 stores the operating system or the application programs in the nonvolatile memory region. The main memory 22 sometimes stores, in the nonvolatile or volatile memory region, data necessary for the processor 21 to execute processing for controlling the sections. The main memory 22 uses the volatile memory region as a work area in which data is rewritten as appropriate by the processor 21. The nonvolatile memory region is, for example, a ROM. The volatile memory region is, for example, a RAM.

The auxiliary storage device 23 is equivalent to an auxiliary storage portion of the computer. For example, an EEPROM, a HDD, or an SSD can be the auxiliary storage device 23. The auxiliary storage device 23 saves data used by the processor 21 in performing various kinds of processing, data created by processing in the processor 21, or the like. The auxiliary storage device 23 sometimes stores the application programs.

The communication unit 24 controls data communication performed according to a communication protocol between the communication unit 24 and the store server 10 connected via the network 40.

The touch panel 25 is a device including both of an input device and a display device of the accounting machine 20. The touch panel 25 detects a touch position on a displayed image and outputs information concerning the touch position to the processor 21.

The printer 26 issues a receipt by printing various character strings, images, or the like on a receipt sheet. As the printer 26 of this type, for example, a thermal printer or a dot impact printer can be used.

The reader writer 27 has a function of reading data recorded in a recording medium and a function of writing data in the recording medium. The reader writer 27 may be a reader writer of a contact type or may be a reader writer of a noncontact type. The recording medium is a card for settlement such as a credit card, a debit card, an electronic money card, or a prepaid card. A wireless communication device such as a smartphone having a function equivalent to the card for settlement may be used as the recording medium.

The fingerprint sensor 28 reads a fingerprint of a person with, for example, a capacitance system. Specifically, the fingerprint sensor 28 detects unevenness of a finger put on a sensor section as a ratio of electric charges accumulated in an electrode of the sensor section and converts an amount of the electric charges into a fingerprint image and outputs the fingerprint image to the processor 21. The fingerprint sensor 28 is not limited to the capacitance system. For example, a fingerprint sensor of an optical system, a field intensity measurement system, a pressure sensitive system, or a thermosensitive system may be used as the fingerprint sensor 28.

The human sensor 29 detects presence of a person standing in front of the accounting machine 20 using, for example, an infrared ray or an ultrasonic wave. The human sensor 29 is turned on if detecting presence of a person.

The change machine 210 receives a deposited coin and a deposited bill. The change machine 210 discharges a coil and a bill as change.

In a plurality of accounting machines 20 including the circuit component elements explained above, accounting machine IDs allocated to each of the accounting machines 20 in order to respectively identify the accounting machines 20 are set. The accounting machine IDs are stored in, for example, the auxiliary storage device 23.

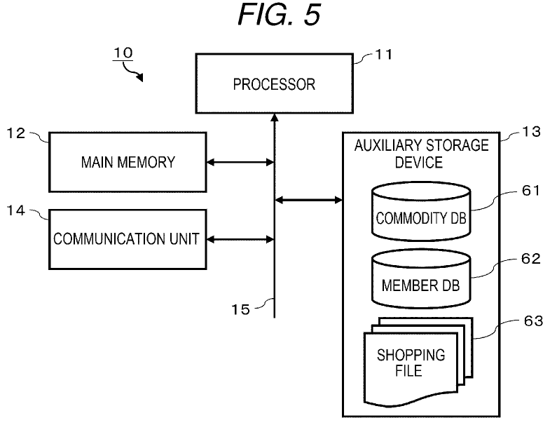

FIG. 5 is a block diagram illustrating a main part circuit configuration of the store server 10. The store server 10 includes a processor 11, a main memory 12, an auxiliary storage device 13, a communication unit 14, and a system transmission path 15. The system transmission path 15 includes an address bus, a data bus, and a control signal line. In the store server 10, the processor 11, the main memory 12, the auxiliary storage device 13, and the communication unit 14 are connected to the system transmission path 15. In the store server 10, a computer is configured by the processor 11, the main memory 12, and the auxiliary storage device 13 and the system transmission path 15 that connects these devices.

The processor 11 is equivalent to a center portion of the computer. The processor 11 controls the sections in order to realize various functions of the store server 10 according to the operating system or the application programs. The processor 11 is, for example, a CPU.

The main memory 12 is equivalent to a main storage portion of the computer. The main memory 12 includes a nonvolatile memory region and a volatile memory region. The main memory 12 stores the operating system or the application programs in the nonvolatile memory region. The main memory 12 sometimes stores, in the nonvolatile or volatile memory region, data necessary for the processor 11 to execute processing for controlling the sections. The main memory 12 uses the volatile memory region as a work area in which data is rewritten as appropriate by the processor 11. The nonvolatile memory region is, for example, a ROM. The volatile memory region is, for example, a RAM.

The auxiliary storage device 13 is equivalent to an auxiliary storage portion of the computer. For example, an EEPROM, a HDD, or an SDD can be the auxiliary storage device 13. The auxiliary storage device 13 saves data used by the processor 11 in performing various kinds of processing or data created by processing in the processor 11. The auxiliary storage device 13 sometimes stores the application programs.

The communication unit 14 controls data communication performed according to a communication protocol between the communication unit 14 and the accounting machine 20 or the information terminal 30 connected via the network 40.

In the store server 10 including the circuit component elements explained above, a commodity database 61 and a member database 62 are saved in the auxiliary storage device 13. A region for saving a plurality of shopping files 63 is formed in the auxiliary storage device 13.

A commodity data record created for each of commodities sold in the store is described in the commodity database 61. The commodity data record includes items such as a commodity ID, a commodity name, and a price. The commodity ID is a unique code set for each of commodities in order to respectively identify the commodities. The commodity name and the price are a name of the commodity specified by the commodity ID and a sales price per one item of the commodity.

The member database 62 saves a member data record 62R created for each of customers who perform membership registration in order to use the store system 1.

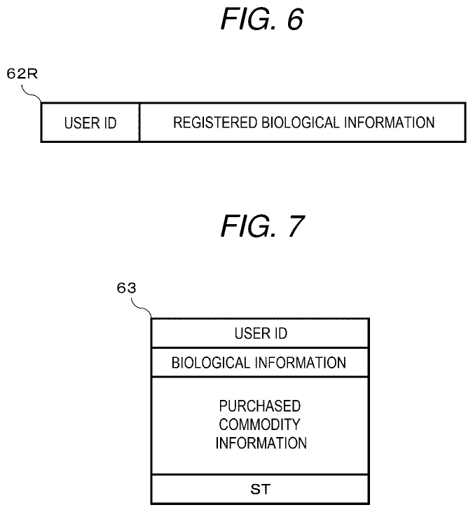

FIG. 6 is a schematic diagram illustrating a main data structure of the member data record 62R. As illustrated in FIG. 6, the member data record 62R includes a user ID and registered biological information. The registered biological information is fingerprint data of a user identified by the user ID, that is, a customer who performs membership registration. The customer who performs the membership registration registers a fingerprint of the customer in the store system 1 before using the store system 1. The customer may register a fingerprint of any finger. However, the fingerprint is desirably at least a fingerprint of a finger detected by the first fingerprint sensor 38a or the second fingerprint sensor 38b if the customer grasps the grips G1 and G2 of the cart C. The member database 62 configures a first storing section that stores identification information of a plurality of users, that is, registered biological information registered in association with user IDs as biological information of users identified by the user IDs. In the following explanation, fingerprint data recorded as the registered biological information in the member data record 62R is referred to as registered fingerprint data. The registered fingerprint data is an example of the registered biological information.

A registration method for a fingerprint is not particularly limited. An existing registration method for fingerprint authentication can be applied. It is also possible to register a fingerprint using the information terminal 30. That is, a fingerprint registration mode is provided as an operation mode of the information terminal 30. If the fingerprint registration mode is set in the information terminal 30, the processor 31 receives a user ID. If the user ID is read via the reader 37, the processor 31 receives fingerprint data. If a fingerprint is read by at least one of the first fingerprint sensor 38a and the second fingerprint sensor 38b, the processor 31 performs control to transmit the user ID and the fingerprint data to the store server 10 together with information indicating the fingerprint registration mode. If receiving data including the information indicating the fingerprint registration mode, the processor 11 of the store server 10 records, in the member data record 62R in which the user ID included in the data is recorded, the fingerprint data received together with the user ID. With such a configuration, it is possible to register the fingerprint of the user in the member database 62 using the information terminal 30.

FIG. 7 is a schematic diagram illustrating a data structure of the shopping file 63. A user ID, biological information, purchased commodity information, and a status are described in the shopping file 63. In FIG. 7, the status is represented as “ST”. The biological information is fingerprint data of a customer identified by the user ID. The fingerprint data is registered fingerprint data registered in the member database 62. The fingerprint data may be fingerprint data read via the first fingerprint sensor 38a or the second fingerprint sensor 38b. The purchased commodity information is information concerning commodities purchased by the customer identified by the user ID. The purchased commodity information includes a commodity ID, a commodity name, and a price. The status is information representing a state of the customer identified by the user ID. As the state of the customer, there are shopping, accounting waiting, and accounting end. In this embodiment, a status in the shopping is represented as “0”, a status in the accounting waiting is represented as “1”, and a status in the accounting end is represented as “2”.

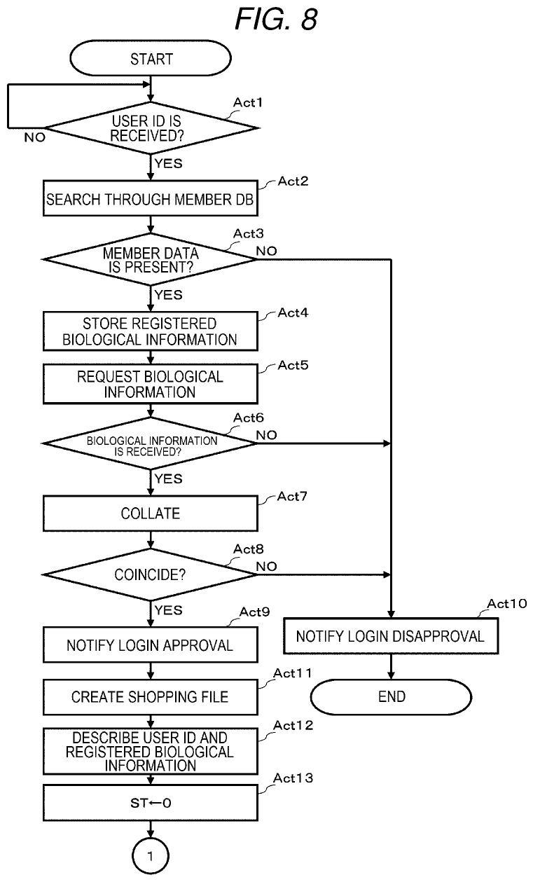

An operation in the case in which a customer performs information input to accounting of commodities purchased by the customer using the store system 1 is explained using flowcharts of FIGS. 8 to 10. FIGS. 8 to 10 are flowcharts illustrating a procedure of main information processing executed by the processor 11 of the store server 10. The operation illustrated in FIGS. 8 to 10 and explained below is an example. A processing procedure and processing content of the operation are not particularly limited if the same result can be obtained.

First, when visiting the store, the customer secures the cart C not in use. The customer causes the reader 37 provided in the cart C to read data of a member card of the customer. If detecting that the data of the member card is read by the reader 37, the processor 31 of the information terminal 30 controls the wireless unit 34 to transmit the data to the store server 10. The data of the member card is wirelessly transmitted from the wireless unit 34 according to this control. The wirelessly transmitted data of the member card is received by the access point 50 and sent to the store server 10 via the network 40. The data of the member card includes a user ID, which is identification information, of the customer who uses the cart C.

The processor 11 of the store server 10 waits for reception of a user ID in Act 1 in FIG. 8. If confirming that data received via the communication unit 14 is data of a member card, the processor 11 determines YES in Act 1 and proceeds to Act 2. In Act 2, the processor 11 describes, in the work area of the main memory 12, the user ID included in the data of the member card. The processor 11 searches through the member database 62 using the user ID as a key for search. In Act 3, the processor 11 determines presence or absence of the member data record 62R in which the user ID, which is the key for search, is described.

If confirming that the pertinent member data record 62R is present, the processor 11 determines YES in Act 3 and proceeds to Act 4. In Act 4, the processor 11 detects registered fingerprint data, which is registered biological information, from the member data record 62R and describes the registered fingerprint data in the work area of the main memory 12. In Act 5, the processor 11 controls the communication unit 14 to transmit a biological information request command to the information terminal 30 at a data transmission source of the member card. According to this control, the biological information request command is transmitted from the communication unit 14 to the information terminal 30 at the data transmission source. The biological information request command is sent to the access point 50 via the network 40 and wirelessly transmitted from the access point 50. The wirelessly transmitted biological information request command is received by the wireless unit 34 of the information terminal 30.

The processor 31 of the information terminal 30 receiving the biological information request command via the wireless unit 34 causes the touch panel 35 to display guidance for requesting the customer to input biological information. For example, the processor 31 causes the touch panel 35 to display guidance “Please grasp the grip to move the cart. Fingerprint authentication is performed”. At this time, the same guidance may be output as voice by a voice synthesis function of the table terminal TM.

The customer confirming the guidance grasps the grips G1 and G2 in order to move the cart C. At this time, the customer may grasp the grips G1 and G2 with both hands or may grasp the grip G1 or G2 with one hand. If the customer grasps the grips G1 and G2, a fingerprint of at least one finger is read by the first fingerprint sensor 38a or the second fingerprint sensor 38b. If the fingerprint is read, the processor 31 controls the wireless unit 34 to transmit fingerprint data representing an image of the fingerprint to the store server 10. According to this control, the fingerprint data is wirelessly transmitted from the wireless unit 34. The wirelessly transmitted fingerprint data is received by the access point 50 and sent to the store server 10 via the network 40.

In Act 6, the processor 11 that controls the transmission of the biological information request command in Act 5 waits for transmission of biological information from the information terminal 30 at the command transmission destination. If detecting that fingerprint data is received by the communication unit 14 from the information terminal 30 at the command transmission destination within a fixed time after the transmission of the biological information request command, the processor 11 determines YES in Act 6 and proceeds to Act 7. In Act 7, the processor 11 collates the fingerprint data and the registered fingerprint data stored in the main memory 12. In Act 8, the processor 11 confirms whether the fingerprint data coincides with at least one fingerprint data in the registered fingerprint data.

As a result of the confirmation, if fingerprint data received from the information terminal 30 coincides with at least one fingerprint data in the registered fingerprint data, the processor 11 determines YES in Act 8 and proceeds to Act 9. In Act 9, the processor 11 controls the communication unit to transmit a response signal of a login approval notification to the information terminal 30 at a fingerprint data transmission source. According to this control, the response signal of the login approval notification is transmitted from the communication unit 14 to the information terminal 30 at the fingerprint data transmission source. The response signal is sent to the access point 50 via the network 40 and wirelessly transmitted from the access point 50. The wirelessly transmitted response signal is received by the wireless unit 34 of the information terminal 30.

The processor 31 of the information terminal 30 receiving the response signal of the login approval notification via the wireless unit 34 comes into an input standby state for commodity information. The processor 31 causes the touch panel 35 to display guidance for notifying that the information terminal 30 starts. For example, the processor 31 causes the touch panel 35 to display guidance “Login authentication is successful. Please begin shopping”. At this time, the same guidance may be output as voice by the voice synthesis function of the tablet terminal TM.

As a result of the confirmation, if the fingerprint data received from the information terminal 30 does not coincide with the registered fingerprint data, the processor 11 determines NO in Act 8 and proceeds to Act 10. In Act 10, the processor 11 controls the communication unit 14 to transmit a response signal of login disapproval notification to the information terminal 30 at the fingerprint data transmission source. According to this control, the response signal of the login disapproval notification is transmitted from the communication unit 14 to the information terminal 30 at the fingerprint data transmission source. The response signal is sent to the access point 50 via the network 40 and wirelessly transmitted from the access point 50. The wirelessly transmitted response signal is received by the wireless unit 34 of the information terminal 30.

The processor 31 of the information terminal 30 receiving the response signal of the login disapproval notification via the wireless unit 34 does not come into the input standby state for commodity information. The processor 31 causes the touch panel 35 to display guidance for notifying that the information terminal 30 does not start. For example, the processor 31 causes the touch panel 35 to display guidance “Login authentication is unsuccessful. Please log in again”. At this time, the same guidance may be output as voice by the voice synthesis function of the tablet terminal TM.

The computer configured mainly by the processor 11 of the store server 10 functions as an identification-information acquiring section by cooperating with the communication unit 14 to execute the processing in Act 1. The computer functions as a first biological-information acquiring section by cooperating with the communication unit 14 to execute the processing in Act 5 and ACT 6. The computer functions as a first collating section by cooperating with the auxiliary storage device 13 to execute the processing in Act 2 to Act 4 and Act 7. The computer functions as a starting section by cooperating with the communication unit 14 to execute the processing in Act 9.

If the processor 11 searches through the member database 62 but cannot confirm the presence of the pertinent member data record 62R, the processor 11 determines NO in Act 3 and proceeds to Act 10. Similarly, if the processor 11 cannot receive fingerprint data within a fixed time after the transmission of the biological information request command, the processor 11 determines NO in Act 6 and proceeds to Act 10. That is, in Act 10, the processor 11 controls the communication unit 14 to transmit the response signal of the login disapproval notification to the information terminal 30 at the fingerprint data transmission source.

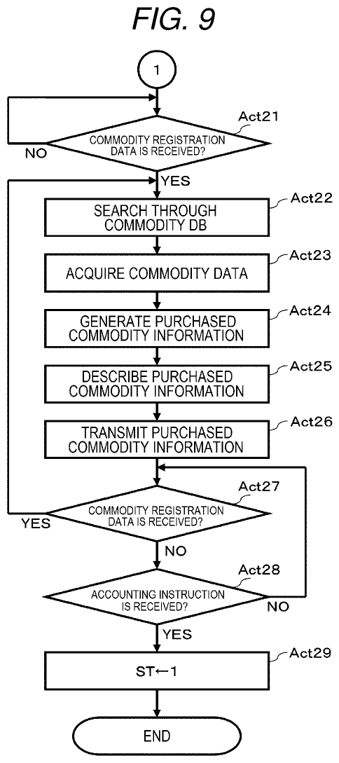

In Act 11, the processor 11 that performs control to transmit the response signal of the login approval notification in Act 9 creates the shopping file 63 in the auxiliary storage device 13. In Act 12, the processor 11 describes, in the shopping file 63, the user ID and the registered biological information described in the work area of the main memory 12. In Act 13, the processor 11 sets the status of the shopping file 63 to “0”, that is, the state of shopping. Thereafter, the processor 11 proceeds to Act 21 in FIG. 9.

The computer configured mainly by the processor 11 of the store server 10 functions as a second storing section by cooperating with the auxiliary storage device 13 to execute the processing in Act 11 and Act 12.

The customer confirming the start of the information terminal 30 begins shopping. If finding, in a selling area, a commodity that the customer desires to purchase, the customer inputs a commodity ID of the commodity to the information terminal 30. For example, in the case of a commodity attached with a code symbol such as a barcode, the customer inputs the commodity ID by causing the scanner 36 to read the code symbol. In the case of a perishable food not attached with a code symbol, the customer touches a commodity button displayed on the touch panel 35 to input the commodity ID. If detecting the input of the commodity ID, the processor 31 of the information terminal 30 controls the wireless unit 34 to transmit the commodity ID to the store server 10. According to this control, data including the commodity ID is wirelessly transmitted from the wireless unit 34. The data includes the user ID input in the login authentication other than the commodity ID. The wirelessly transmitted data including the commodity ID and the user ID is received by the access point 50 and sent to the store server 10 via the network 40. In the following explanation, the data including the commodity ID and the user ID is referred to as commodity registration data.

In Act 21 in FIG. 9, the processor 11 waits for reception of the commodity registration data. If confirming that the data received via the communication unit 14 is the commodity registration data, the processor determines YES in Act 21 and proceeds to Act 22. In Act 22, the processor 11 describes, in the work area of the main memory 12, the commodity ID and the user ID included in the commodity registration data. The processor 11 searches through the commodity database 61 using the commodity ID described in the work area as a key for search. In Act 23, the processor 11 acquires, from the commodity database 61, a commodity data record in which the commodity ID, which is the key for search, is described.

In Act 24, the processor 11 generates purchased commodity information based on the commodity ID, a commodity name, a price, and the like described in the commodity data record. In Act 25, the processor 11 detects, from the auxiliary storage device 13, the shopping file 63 including the user ID described in the work area and describes the purchased commodity information in the shopping file 63.

In Act 26, the processor 11 controls the communication unit 14 to transmit the purchased commodity information. According to this control, the purchased commodity information is transmitted from the communication unit 14 to the information terminal 30, which is a transmission source of the commodity registration data. The purchased commodity information is sent to the access point 50 via the network 40 and wirelessly transmitted from the access point 50. The wirelessly transmitted purchased commodity information is received by the wireless unit 34 of the information terminal 30.

The processor 31 of the information terminal 30 receiving the purchased commodity information via the wireless unit 34 causes the touch panel 35 to display the commodity name, the price, and the like included in the purchased commodity information.

The customer confirming the display of the commodity name, the price, and the like of the commodity to be purchased on the touch panel 35 continues the shopping. If finding a commodity that the customer desires to purchase, the customer inputs a commodity ID of the commodity to the information terminal 30. If detecting that the commodity ID is input, the processor 31 of the information terminal 30 controls the wireless unit 34 to transmit the commodity ID to the store server 10 in the same manner as explained above. According to this control, commodity registration data is wirelessly transmitted from the wireless unit 34.

The customer repeats work for, every time the customer finds a commodity that the customer desires to purchase, inputting a commodity ID of the commodity to the information terminal 30. If finishing the shopping in the selling area, the customer touches an image of an accounting button displayed on the touch panel 35. If detecting that the image of the accounting button is touched, the processor 31 of the information terminal 30 controls the wireless unit 34 to transmit an accounting instruction command to the store server 10. According to this control, the accounting instruction command is wirelessly transmitted from the wireless unit 34. The accounting instruction command includes the user ID input in the login authentication.

If finishing the processing in Act 26, the processor 11 of the store server 10 proceeds to Act 27. In Act 27, the processor 11 confirms whether the commodity registration data is received. If the commodity registration data is not received (NO in Act 27), the processor 11 determines NO in Act 27 and proceeds to Act 28. In Act 28, the processor 11 confirms whether the accounting instruction command is received. If the accounting instruction command is not received, the processor 11 determines NO in Act 28 and returns to Act 27. The processor 11 waits for reception of the commodity registration data or and reception of the accounting instruction command in Act 27 and Act 28.

If detecting reception of the commodity registration data in this waiting state, the processor 11 determines YES in Act 27 and returns to Act 22. The processor 11 executes the processing in Act 22 to Act 26 in the same manner as explained above. Thereafter, the processor 11 comes into the waiting state in Act 27 and Act 28.

If detecting reception of the accounting instruction command in the waiting state, the processor 11 determines YES in Act 28 and proceeds to Act 29. In Act 29, the processor 11 updates the status of the shopping file 63, in which the user ID included in the accounting instruction command is set, from “0” to “1”, that is, the accounting waiting. The processor 11 ends the information processing derived by the reception of the user ID in Act 1.

The computer configured mainly by the processor 11 of the store server 10 functions as an updating section by cooperating with the communication unit 14 and the auxiliary storage device 13 to execute the processing in Act 28 and Act 29.

The customer touching the image of the accounting button moves to a setting place of the accounting machine 20 not in use. If the customer moves to the setting place of the accounting machine 20, the human sensor 29 of the accounting machine 20 is turned on. If the human sensor 29 is turned on, the processor 21 of the accounting machine 20 performs control to transmit human sensor ON data to the store server 10. According to this control, the human sensor ON data is output from the communication unit 24. The human sensor ON data includes an accounting machine ID set in the accounting machine 20. The human sensor ON data output from the communication unit 24 is sent to the store server 10 through the network 40 and received by the communication unit 14 of the store server 10.

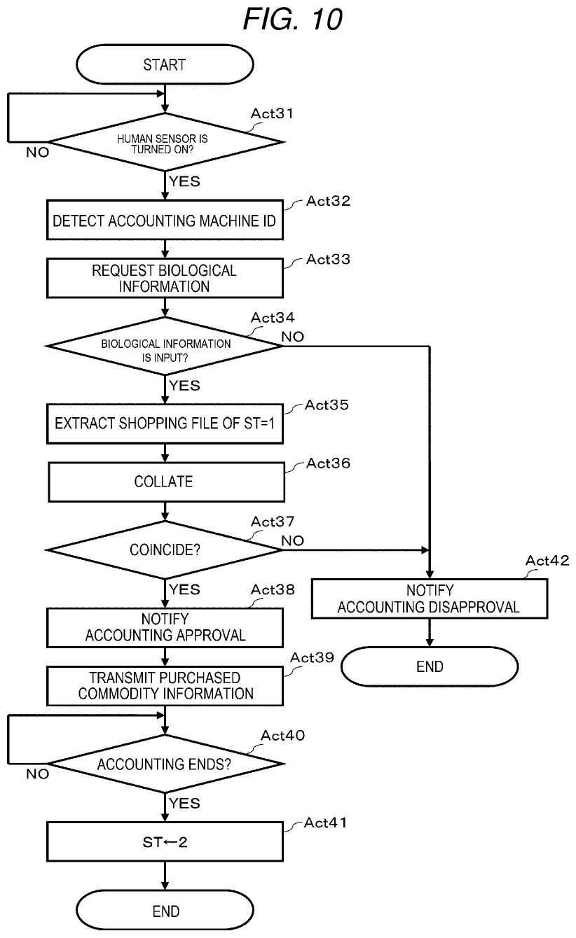

In Act 31 in FIG. 10, the processor 11 of the store server 10 waits for the human sensor ON data. If detecting reception of the human sensor ON data via the communication unit 14, in Act 32, the processor 11 detects the accounting machine ID included in the human sensor ON data and describes the accounting machine ID in the work area of the main memory 22. In Act 33, the processor 21 controls the communication unit 14 to transmit a biological information request command to the accounting machine 20 at a human sensor ON data transmission source. According to this control, the biological information request command is transmitted from the communication unit 14 to the accounting machine 20 at the human sensor ON data transmission source. The biological information request command is sent to the accounting machine 20 via the network 40.

The processor 21 of the accounting machine 20 receiving the biological information request command via the communication unit 24 causes the touch panel 25 to display guidance for requesting the customer moving to the accounting place to input biological information. For example, the processor 21 causes the touch panel 25 to display guidance “Please put a finger on the fingerprint sensor”. At this time, the same guidance may be output as voice by the voice synthesis function of the accounting machine 20.

The customer confirming the guidance puts a finger on the fingerprint sensor 28 included in the accounting machine 20. At this time, the customer may put any finger on the fingerprint sensor 28. However, the customer puts at least a finger, fingerprint data of which is registered as registered biological information. If a finger is put on the fingerprint sensor 28, a fingerprint of the finger is read by the fingerprint sensor 28. If the fingerprint is read, the processor 21 controls the communication unit 24 to transmit fingerprint data representing an image of the fingerprint to the store server 10. According to this control, the fingerprint data is sent from the communication unit 24 to the store server 10 via the network 40.

In Act 34, the processor 11 that controls the transmission of the biological information request command in Act 33 waits for transmission of biological information from the accounting machine 20 at a command transmission destination. If detecting that the fingerprint data is received by the communication unit 14 within a fixed time after the transmission of the biological information request command, the processor 11 determines YES in Act 34 and proceeds to Act 35. In Act 35, the processor 11 extracts, out of all the shopping files saved in the auxiliary storage device 13, the shopping file 63, the status of which is “1”, that is, the accounting waiting state. In Act 36, the processor 11 collates the fingerprint data received from the accounting machine 20 with the biological information described in the extracted shopping file 63. In Act 37, the processor 11 determines presence or absence of the shopping file 63 in which fingerprint data coinciding with the fingerprint data received from the accounting machine 20 is described as biological information.

If confirming that the pertinent shopping file 63 is present, the processor 11 determines YES in Act 37 and proceeds to Act 38. In Act 38, the processor 11 controls the communication unit 14 to transmit a response signal of an accounting approval notification to the accounting machine 20 identified by the accounting machine ID described in the work area. In Act 39, the processor 11 controls the communication unit 14 to collectively transmit purchased commodity information of the shopping file 63, in which fingerprint data coinciding with the fingerprint data received from the accounting machine 20 is described as biological data, to the accounting machine 20. According to these kinds of control, the response signal of the accounting approval notification and the purchased commodity information are transmitted from the communication unit 14 to the accounting machine 20 at a fingerprint data transmission source. These transmission data are transmitted to the accounting machine 20 via the network 40.

The processor 21 of the accounting machine 20 receiving the response signal of the accounting approval notification via the communication unit 24 executes accounting processing based on the purchased commodity information received following the response signal. For example, the processor 21 causes the touch panel 25 to display a total amount calculated based on the purchased commodity information and waits for payment of a price. If confirming that a price equivalent to the total amount is paid via the change machine 210, the processor 21 generates receipt data based on the purchased commodity information and operates the printer 26 to issue a receipt. Such accounting processing is well-known processing carried out in the existing accounting machine 20. Therefore, detailed explanation of the accounting processing is omitted. If finishing the accounting processing, the processor 21 transmits an accounting end command to the store server 10.

In Act 40, the processor 11 of the store server 10 that controls the transmission of the purchased commodity information in Act 39 waits for transmission of the accounting end command from the accounting machine 20 at a purchased commodity information transmission destination. If detecting reception of the accounting end command via the communication unit 14, the processor 11 determines YES in Act 40 and proceeds to Act 41. In Act 41, the processor 11 updates the status of the shopping file 63, in which fingerprint data coinciding with the fingerprint data received from the accounting machine 20 is described, from “1” to “2”, that is, the state of accounting end. The processor 11 ends the information processing derived by receiving the human sensor ON data in Act 31.

The computer configured mainly by the processor 11 of the store server 10 functions as a second biological-information acquiring section by cooperating with the communication unit 14 to execute the processing in Act 32 to Act 34. The computer functions as a second collating section by cooperating with the auxiliary storage device 13 to execute the processing in Act 35 and Act 36. The computer functions as a transmitting section by cooperating with the communication unit 14 to execute the processing in Act 37 to Act 39.

If fingerprint data cannot be received within a fixed time after the transmission of the biological information request command, the processor 11 determines NO in Act 34 and proceeds to Act 42. If the shopping file 63, in which fingerprint data coinciding with the fingerprint data received from the accounting machine 20 is described, is absent, the processor 11 determines NO in Act 37 and proceeds to Act 42. In Act 42, the processor 11 controls the communication unit 14 to transmit a response signal of an accounting disapproval notification to the accounting machine 20 at the human sensor ON data transmission source or the fingerprint data transmission source. According to this control, the response signal of the accounting disapproval notification is transmitted from the communication unit 14 to the accounting machine 20 at the human sensor ON data transmission source or the fingerprint data transmission source. The transmission data is transmitted to the accounting machine 20 via the network 40.

The processor 21 of the accounting machine 20 receiving the response signal of the accounting disapproval notification via the communication unit 24 causes the touch panel 25 to display guidance for notifying the customer that accounting cannot be performed, for example, “Fingerprint authentication is unsuccessful. Please pat at a manned register”. The processor 11 ends the information processing derived by receiving the human sensor ON data in Act 31.

As explained above, according to this embodiment, a fingerprint, which is a kind of biological information, can be applied to login authentication of the information terminal 30. Therefore, identity fraud by an outsider can be surely prevented. Moreover, the registered fingerprint data used for the fingerprint authentication is only the registered fingerprint data described in one member data record 62R specified by the user ID of the member card read by the reader 37 of the cart C. Therefore, a processing time required for the fingerprint authentication is extremely short. Accordingly, it is unlikely that the driving of the information terminal 30 is delayed and the customer feels the delay unpleasant.

In this embodiment, a customer grasps the grips G1 and G2 in order to move the cart C, whereby a fingerprint of the customer is read and fingerprint authentication is performed. Therefore, a special operation is unnecessary to read the fingerprint. Accordingly, a burden on the customer does not increase even if the fingerprint authentication is introduced.

If approving login of the information terminal 30 through the fingerprint authentication, the store server 10 creates the shopping file 63 including a user ID of a member card read by the reader 37 of the information terminal 30. The store server 10 describes, in the shopping file 63, purchased commodity information of a commodity, information of which is input in the information terminal 30. The store server 10 describes, in the shopping file 63, registered fingerprint data used in the fingerprint authentication. Therefore, according to this embodiment, it is possible to save, in association with the registered fingerprint data used in the fingerprint authentication, the purchased commodity information of the commodity, the information of which is input in the information terminal 30 approved to log in by the fingerprint authentication.

The status is included in the shopping file 63. The status is “0”, that is, the state of shopping until an accounting instruction is performed by the information terminal 30. The status changes to “1”, that is, the accounting waiting if the accounting instruction is performed. The purchased commodity information described in the shopping file 63 is used for the accounting processing in the accounting machine 20.

If fingerprint data is read by the fingerprint sensor 28 provided in the accounting machine 20, the store server 10 collates the fingerprint data and the registered fingerprint data described in the shopping file 63, the status of which is “1”. The store server 10 downloads the purchased commodity information of the shopping file 63, in which the registered fingerprint data coinciding with the fingerprint data is described, to the accounting machine 20 at the fingerprint data transmission source. As a result, the accounting machine 20 executes the accounting processing based on the purchased commodity information.

As explained above, according to this embodiment, the customer can download purchased commodity information of the customer to the accounting machine 20 simply by moving to the accounting machine 20 not in use and causing the accounting machine 20 to read a fingerprint. Therefore, special information processing for guiding the customer to the accounting machine 20 is unnecessary in the store server 10. As a result, a processing load of the store server 10 can be reduced. Moreover, the registered fingerprint data used for the fingerprint authentication is only the registered fingerprint data described in the shopping file 63, the status of which is “1”. Therefore, a processing time required for the fingerprint authentication is short. Accordingly, it does not occur that a time required until the purchased commodity information is downloaded increases because of the introduction of the finger authentication and the customer is dissatisfied with the increase in the time.

The embodiment of the terminal control apparatus and the store system that can reduce, using biological authentication, a time required for a start of a terminal while surely preventing identity fraud by an outsider is explained above. However, the embodiment is not limited to this.

In the embodiment, the biological authentication is the fingerprint authentication. However, a type of the biological authentication is not limited to the fingerprint authentication and may be, for example, iris authentication, vein authentication, and voiceprint authentication.

In the embodiment, the store system 1 of the self-type in which a customer himself or herself performs an information input to accounting of a commodity to be purchased is illustrated. However, the store system is not limited to this. For example, the accounting machine 20 may be an accounting machine for a manned register in which processing is performed by a store clerk called casher.

In the embodiment, the grips G1 and G2 attached to the handlebar C22 on the left and the right of the scanner 36 is illustrated. However, the grips G1 and G2 may be integrated and the scanner 36 may be attached to substantially the center of the grips G1 and G2. In the embodiment, the first fingerprint sensor 38a and the second fingerprint sensor 38b are respectively provided in the grips G1 and G2. However, one fingerprint sensor may be only provided in one of the grips G1 and G2. The fingerprint sensor may be present in a place other than the grip.

In the embodiment, the biological information described in the shopping file 63 is the registered fingerprint data. However, the biological information does not always have to be the registered biological data. The biological information may be the fingerprint data used for the collation with the registered biological data, that is, the data of the fingerprint read by the first fingerprint sensor 38a and the second fingerprint sensor 38b. Even in that case, by putting a finger, a fingerprint of which is read by the first fingerprint sensor 38a and the second fingerprint sensor 38b, on the fingerprint sensor 28 of the accounting machine 20, the customer can download purchased commodity information of a commodity purchased by the customer to the accounting machine 20.

In the embodiment, the shopping file 63, in which the registered fingerprint data collated with the fingerprint data read by the fingerprint sensor 28 of the accounting machine 20 is described, is limited to the shopping file 63, the status of which is “1”. However, the shopping file 63 does not always have to be limited. For example, the shopping file 63, the status of which is “0”, may be included.

In general, a transfer of the store server 10 is performed in a state in which the programs are stored in the ROM. However, not only this, but the store server 10 may be transferred in a state in which the programs are not stored in the ROM. In this case, programs transferred separately from the store server 10 are written in a writable storage device included in the store server 10 according to operation of the user or the like. The transfer of the programs can be performed by recording the programs in a removable recording medium or may be performed by communication via a network. A form of the recording medium may be any form if the recording medium is a recoding medium that can store the programs and can be read by a device like a CD-ROM and a memory card.

The several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A terminal control apparatus, comprising:
an identification-information acquiring component configured to acquire identification information of a user;
a first biological-information acquiring component configured to acquire biological information of the user read by a biological information reading device provided in a truck;
a first collating component configured to detect, from a first storing component that stores, in association with the identification information of a plurality of users, registered biological information registered as biological information of the user identified by the identification information, the registered biological information stored in association with the identification information acquired by the identification-information acquiring component and collate the detected registered biological information and the biological information acquired by the first biological-information acquiring component; and
a starting component configured to start, if the biological information coincides with the registered biological information as a result of the collation by the first collating component, a terminal for inputting information concerning a commodity that the user loads on the truck.

2. The apparatus according to claim 1, further comprising a second storing component configured to store, in association with the biological information or the registered biological information collated by the first collating component, the information concerning the commodity input by the terminal started by the starting component.

3. The apparatus according to claim 2, further comprising:
a second biological-information acquiring component configured to acquire biological information of the user read by a biological information reading device provided in an accounting machine;
a second collating component configured to collate the biological information or the registered biological information stored by the second storing component and the biological information acquired by the second biological-information acquiring component; and
a transmitting component configured to transmit, if the biological information acquired by the second biological-information acquiring component coincides with the biological information or the registered biological information stored by the second storing component as a result of the collation by the second collating component, the information concerning the commodity stored in association with the biological information or the registered biological information by the second storing component to the accounting machine.

4. The apparatus according to claim 2, wherein
the information stored in association with the biological information or the registered biological information by the second storing component includes a status indicating whether the user is in a state of shopping or a state of accounting waiting, and
the apparatus further comprises an updating component configured to update, if detecting an accounting instruction from an accounting instructing component provided in the terminal, the status stored together with the information concerning the commodity input by the terminal from the state of shopping to the state of accounting waiting.

5. The apparatus according to claim 4, further comprising:
a second biological-information acquiring component configured to acquire biological information of the user read by a biological information reading device provided in an accounting machine;
a second collating component configured to collate the biological information or the registered biological information stored together with the status indicating the state of accounting waiting by the second storing component and the biological information acquired by the second biological-information acquiring component; and
a transmitting component configured to transmit, if the biological information acquired by the second biological-information acquiring component coincides with the biological information or the registered biological information stored by the second storing section as a result of the collation by the second collating component, the information concerning the commodity stored in association with the biological information or the registered biological information by the second storing component to the accounting machine.

6. The apparatus according to claim 1, wherein
the first biological-information acquiring component is a fingerprint reader.

7. The apparatus according to claim 1, wherein
the identification-information acquiring component is an RFID reader.

8. A store system, comprising:
a truck;
a terminal for inputting information concerning a commodity loaded on the truck; and
a terminal control apparatus comprising:
an identification-information acquiring component configured to acquire identification information of a user;
a first biological-information acquiring component configured to acquire biological information of the user read by a biological information reading device provided in the truck;
a first collating component configured to detect, from a first storing component that stores, in association with the identification information, registered biological information registered as biological information of the user identified by the identification information, the registered biological information stored in association with the identification information acquired by the identification-information acquiring component and collate the detected registered biological information and the biological information acquired by the first biological-information acquiring component; and
a starting component configured to start the terminal if the biological information coincides with the registered biological information as a result of the collation by the first collating component, wherein
the biological information reading device reads the biological information of the user from an act of the user for moving the truck.

9. The system according to claim 8, further comprising a second storing component configured to store, in association with the biological information or the registered biological information collated by the first collating component, the information concerning the commodity input by the terminal started by the starting component.

10. The system according to claim 9, further comprising:
a second biological-information acquiring component configured to acquire biological information of the user read by a biological information reading device provided in an accounting machine;
a second collating component configured to collate the biological information or the registered biological information stored by the second storing component and the biological information acquired by the second biological-information acquiring component; and
a transmitting component configured to transmit, if the biological information acquired by the second biological-information acquiring component coincides with the biological information or the registered biological information stored by the second storing component as a result of the collation by the second collating component, the information concerning the commodity stored in association with the biological information or the registered biological information by the second storing component to the accounting machine.

11. The system according to claim 9, wherein
the information stored in association with the biological information or the registered biological information by the second storing component includes a status indicating whether the user is in a state of shopping or a state of accounting waiting, and
the apparatus further comprises an updating component configured to update, if detecting an accounting instruction from an accounting instructing component provided in the terminal, the status stored together with the information concerning the commodity input by the terminal from the state of shopping to the state of accounting waiting.

12. The system according to claim 11, further comprising:
a second biological-information acquiring component configured to acquire biological information of the user read by a biological information reading device provided in an accounting machine;
a second collating component configured to collate the biological information or the registered biological information stored together with the status indicating the state of accounting waiting by the second storing component and the biological information acquired by the second biological-information acquiring component; and
a transmitting component configured to transmit, if the biological information acquired by the second biological-information acquiring component coincides with the biological information or the registered biological information stored by the second storing section as a result of the collation by the second collating component, the information concerning the commodity stored in association with the biological information or the registered biological information by the second storing component to the accounting machine.

13. The system according to claim 8, wherein
the first biological-information acquiring component is a fingerprint reader.

14. The system according to claim 8, wherein
the identification-information acquiring component is an RFID reader.

15. The system according to claim 8, wherein
the truck is a shopping cart.

16. A method of controlling a terminal for inputting information concerning a commodity to be loaded on a truck, comprising:
acquiring identification information of a user;
acquiring biological information of the user read by a biological information reading device provided in the truck;
detecting, from a first storing component that stores, in association with the identification information, registered biological information registered as biological information of the user identified by the identification information, the registered biological information stored in association with the acquired identification information acquired and collating the detected registered biological information and the acquired biological information acquired; and
starting the terminal if the biological information coincides with the registered biological information as a result of the collating.

17. The method according to claim 16, further comprising:
storing, in association with the biological information or the registered biological information collated, the information concerning the commodity input by the starting.

18. The method according to claim 17, further comprising:
acquiring a second biological information of the user provided in an accounting machine;
collating the second biological information or the registered biological information stored and the biological information acquired; and
transmitting, if the biological information acquired coincides with the biological information or the registered biological information stored as a result of the collating, the information concerning the commodity stored in association with the biological information or the registered biological information to the accounting machine.

19. The method according to claim 17, wherein
the information stored in association with the biological information or the registered biological information by the second storing component includes a status indicating whether the user is in a state of shopping or a state of accounting waiting, and
the method further comprising:
updating, if detecting an accounting instruction from an accounting instructing component provided in the terminal, the status stored together with the information concerning the commodity input by the terminal from the state of shopping to the state of accounting waiting.

20. The method according to claim 19, further comprising:
acquiring a second biological information of the user provided in an accounting machine;
collating the second biological information or the registered biological information stored together with the status indicating the state of accounting waiting and the biological information acquired; and
transmitting, if the biological information acquired coincides with the biological information or the registered biological information stored as a result of the collating, the information concerning the commodity stored in association with the biological information or the registered biological information to the accounting machine.
